(19) United States
(12) Patent Application Publication
(10) Pub. No.: US 2024/0051549 A1
(43) Pub. Date: Feb. 15, 2024

(54) SYSTEMS AND METHODS FOR ESTIMATING LATERAL VELOCITY OF A VEHICLE

(71) Applicant: GM GLOBAL TECHNOLOGY OPERATIONS LLC, Detroit, MI (US)

(72) Inventors: Jackson Barry McGrory, Mississauga (CA); Mohammadali Shahriari, Markham (CA); Khizar Ahmad Qureshi, Pickering (CA); Mehdi Abroshan, Waterloo (CA)

(73) Assignee: GM GLOBAL TECHNOLOGY OPERATIONS LLC, Detroit, MI (US)

(21) Appl. No.: 17/819,634

(22) Filed: Aug. 14, 2022

(51) Int. Cl. B60W 40/105; B60W 50/00

(52) U.S. Cl. CPC B60W 40/105; B60W 50/0097; B60W 2554/20; B60W 2520/12; B60W 2552/53; B60W 2050/0022; B60W 2554/801; B60W 2050/0028; B60W 2720/12; B60W 60/001

(57) ABSTRACT

Systems and methods for controlling a vehicle. The systems and methods receive static object detection data from a perception system. The static object detection data includes a first representation of a static object at a current time and a second representation of the static object at an earlier time. The systems and methods receive vehicle dynamics measurement data from the sensor system, determine a current position of the static object based on the first representation of the static object, predict an expected position of the static object at the current time using the second representation of the static object at the earlier time, a motion model and the vehicle dynamics measurement data, estimate a lateral velocity of the vehicle based on a disparity between the current position and the expected position, and control the vehicle using the lateral velocity

### TECHNICAL FIELD

The present disclosure generally relates to vehicles, systems and methods for estimating later velocity.

### INTRODUCTION

Autonomous and semi-autonomous vehicles are capable of sensing their environment and navigating based on the sensed environment. Such vehicles sense their environment using sensing devices such as radar, lidar, image sensors, and the like. The vehicle system further uses information from global positioning systems (GPS) technology, navigation systems, vehicle-to-vehicle communication, vehicle-to-infrastructure technology, and/or drive-by-wire systems to navigate the vehicle.

Vehicle automation has been categorized into numerical levels ranging from Zero, corresponding to no automation with full human control, to Five, corresponding to full automation with no human control. Various automated driver-assistance systems, such as cruise control, adaptive cruise control, and parking assistance systems correspond to lower automation levels, while true “driverless” vehicles correspond to higher automation levels.

Some automated vehicle systems include a perception system that include capability to detect static traffic objects like lane markings, traffic signs, traffic control devices, etc. Automated vehicle control features such as hands-free driving-assistance technology, collision avoidance steering and lane keeping assistance and other steering based automated driving features rely on path planning and path planning accuracy can be improved with an accurate estimation of lateral velocity. Lateral velocity may find application in other automated vehicle control features such as those relying on side slip angle and including model predictive control. Lateral velocity may be estimated using a model based approach but such models need to describe the vehicle to a high degree of accuracy to be reliable and are computationally demanding.

Accordingly, it is desirable to provide systems and methods that estimate lateral velocity independently from complex models so as to achieve increased computational efficiency whilst achieving accurate estimations. Furthermore, other desirable features and characteristics of the present invention will become apparent from the subsequent detailed description and the appended claims, taken in conjunction with the accompanying drawings and the foregoing technical field and background.

### SUMMARY

In one aspect, a method of controlling a vehicle is provided. The method includes: receiving, via at least one processor, static object detection data from a perception system of the vehicle, the static object detection data including a first representation of a static object at a current time and a second representation of the static object at an earlier time; receiving, via the at least one processor, vehicle dynamics measurement data from a sensor system of the vehicle; determining, via the at least one processor, a current position of the static object based on the first representation of the static object; predicting, via the at least one processor, an expected position of the static object at the current time using the second representation of the static object at the earlier time, a motion model and the vehicle dynamics measurement data; estimating, via the at least one processor, a lateral velocity of the vehicle based on a disparity between the current position and the expected position; and controlling, via the at least one processor, the vehicle using the lateral velocity.

In embodiments, the method includes determining, via the at least one processor, an earlier position of the static object using the second representation of the static object at the earlier time, wherein predicting the expected position of static object at the current time uses the second representation of the static object at the earlier time, the motion model, the vehicle dynamics measurement data and the earlier position of the static object.

In embodiments, the disparity is determined by the at least one processor using a window having an overlapping representation of the static object that appears in the first representation and the second representation.

In embodiments, the first representation of the static object and the second representation of the static object are in the form of first and second functions, respectively.

In embodiments, the method includes determining, via the at least one processor, a first set of points coinciding with the first representation of the static object, transforming, via the at least one processor, the first set of points into a coordinate frame of the second representation of the static object using the motion model and the vehicle dynamics measurement data to provide a transformed set of points, wherein predicting, via the at least one processor, the expected position of the static object at the current time uses the second representation of the static object at the earlier time, the motion model, the vehicle dynamic measurement data and the transformed set of points.

In embodiments, the first representation of the static object and the second representation of the static object are in the form of first and second functions, respectively. The method comprises determining, via the at least one processor, a first set of points using the first function, transforming, via the at least one processor, the first set of points into a coordinate frame of the second representation of the static object using the motion model and the vehicle dynamics measurement data to provide a transformed set of points, wherein predicting, via the at least one processor, an expected position of the static object at the current time comprises evaluating the second function with respect to the transformed set of points to provide a second set of points and translating the second set of points into a coordinate from of the first representation to provide an expected set of points. Estimating the lateral velocity of the vehicle is based on a disparity between the first set of points and the expected set of points.

In embodiments, estimating the lateral velocity of the vehicle is based on a function that minimizes an error between the current position and the expected position, wherein the function corresponds to the disparity.

In embodiments, the static object is a lane marking.

In embodiments, the method comprises performing, for each of a plurality of static objects in the static object detection data: the determining the current position of the static object, predicting the expected position of the static object and the estimating the lateral velocity of the vehicle, to thereby provide a plurality of estimates of the lateral velocity of the vehicle, wherein the method comprises combining the plurality of estimates of the lateral velocity to provide a combined estimate, wherein controlling the vehicle is based on the combined estimate.

In embodiments, combining the plurality of estimates includes evaluating a weighted sum function. In embodiments, weights of the weighted sum are set depending on a distance away from the vehicle that each of the static objects is located. In embodiments, weights of the weighted sum are set depending on a perception confidence associated with each static object provided by the perception system.

In embodiments, the method includes excluding a static object from the estimating the lateral velocity of the vehicle when perception confidence provided by the perception system is insufficient and/or when the static object is located too far away from the vehicle according to predetermined exclusion thresholds.

In another aspect, a system for controlling a vehicle is provided. The system includes a perception system, a sensor system, at least one processor in operable communication with the sensor system and the perception system. The at least one processor is configured to execute program instructions. The program instructions are configured to cause the at least one processor to: receive static object detection data from the perception system, the static object detection data including a first representation of a static object at a current time and a second representation of the static object at an earlier time; receive vehicle dynamics measurement data from the sensor system; determine a current position of the static object based on the first representation of the static object; predict an expected position of the static object at the current time using the second representation of the static object at the earlier time, a motion model and the vehicle dynamics measurement data; estimate a lateral velocity of the vehicle based on a disparity between the current position and the expected position; and control the vehicle using the lateral velocity.

In embodiments, the program instructions are configured to cause the at least one processor to: determine an earlier position of the static object using the second representation of the static object at the earlier time, wherein predicting the expected position of static object at the current time uses the second representation of the static object at the earlier time, the motion model, the vehicle dynamics measurement data and the earlier position of the static object.

In embodiments, the disparity is determined by the at least one processor using a window having an overlapping representation of the static object that appears in the first representation and the second representation.

In embodiments, the first representation of the static object and the second representation of the static object are in the form of first and second functions, respectively.

In embodiments, the program instructions are configured to cause the at least one processor to: determine a first set of points coinciding with the first representation of the static object, transform the first set of points into a coordinate frame of the second representation of the static object using the motion model and the vehicle dynamics measurement data to provide a transformed set of points, wherein predicting an expected position of the static object at the current time uses the second representation of the static object at the earlier time, the motion model, the vehicle dynamic measurement data and the transformed set of points.

In embodiments, the first representation of the static object and the second representation of the static object are in the form of first and second functions, respectively, wherein the program instructions are configured to cause the at least one processor to: determine a first set of points using the first function, transform the first set of points into a coordinate frame of the second representation of the static object using the motion model and the vehicle dynamics measurement data to provide a transformed set of points, wherein predicting the expected position of the static object at the current time comprises evaluating the second function with respect to the transformed set of points to provide a second set of points and translating the second set of points into a coordinate from of the first representation to provide an expected set of points, and wherein estimating the lateral velocity of the vehicle is based on a disparity between the first set of points and the expected set of points.

In embodiments, estimating the lateral velocity of the vehicle is based on a function that minimizes an error between the current position and the expected position, wherein the function corresponds to the disparity.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous or semi-autonomous vehicle system utilizing a lateral velocity estimation system, in accordance with various embodiments;

FIG. 2 is a dataflow diagram illustrating an autonomous driving system that includes the lateral velocity estimation system, in accordance with various embodiments;

FIG. 3 is a system diagram illustrating functional blocks of the lateral velocity estimation system, in accordance with various embodiments;

FIG. 4 is a data flow diagram schematically representing a process of comparing static objects and estimating lateral velocity as used by the lateral velocity estimation system, in accordance with various embodiments;

FIG. 5 is a diagram schematically representing static object detections, in accordance with various embodiments;

FIG. 6 is a diagram representing processes for defining valid windows of overlap of static objects for use in estimating lateral velocity, in accordance with various embodiments; and

FIG. 7 is a flowchart illustrating method steps of an algorithmic process to estimate lateral velocity, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

Systems and methods described herein provide an estimation methodology for vehicle model-independent lateral velocity (V_{y}) from simple static objects detected around a vehicle such as processed lane markings. The vehicle's motion with respect to these static objects is used to estimate lateral velocity under low excitation for use in automated driving and active safety features. The systems and methods are computationally efficient and enable enhancement of vehicle parameter estimation and path prediction for features including hands free driving, collision avoidance and full automated driving.

An algorithm described herein assigns confidence values to each object based on corresponding perception signals, driving conditions and heuristics, and selecting a subset of objects to use for lateral velocity estimation. In one embodiment, the algorithm determine a set of points belonging to an object that are contained in two subsequent detections of that object. In embodiments, the algorithm estimates the vehicle's lateral velocity from these subsequent sets of points, and other standard measurement from vehicle dynamics sensors. In some embodiments, the algorithm uses the confidence assigned to each detected object to fuse the corresponding estimates of lateral velocity into a single estimate.

Accordingly, there is disclosed systems and methods that implement an algorithm for estimating lateral velocity that includes the step of receiving a set of data representing static objects or road features generated by a perception system. The algorithm may represent the objects or features by mathematical functions such as polynomials relating X and Y coordinates. The algorithm may assign confidence values to each object/feature based on perception signals (camera view range, confidence), driving conditions (speed, curvature) and heuristics (lane scenarios). Objects/features that do not meet a confidence threshold are excluded from subsequent calculations. As disclosed herein, the static object/feature's representation relative to the vehicle is available at two successive times. The algorithm may determines a set of points in global space that are found in both of the representations. The algorithm uses the two sets of points, along with vehicle speed and yaw rate, to estimate the vehicle's lateral velocity during the time between the two detections. Some points within the set may be weighted more heavily in their bearing on the lateral velocity estimate from that object/feature based on confidence score and/or distance from the vehicle. The lateral velocity estimate corresponding to each object/feature may be fused to provide a single model-independent estimate. The fusion of multiple sources may be weighted as a function of the confidence assigned to each object/feature.

The systems and methods described herein provide model independent lateral velocity that can be used for: parameter estimation (estimation of tire slip and forces), state estimation, path prediction, time-to-lane-crossing or time-to-collision, feedback control, control performance indicator, skid/slip/nonlinear region detection. The computationally efficient method described herein is accurate under low sideslip conditions (typical highway/hands-free driving). The method is subject to a low computational cost by being formulated as linear regression problem. The system is operable with a minimum requirement of a monocular camera. The algorithm includes safeguards against perception anomalies.

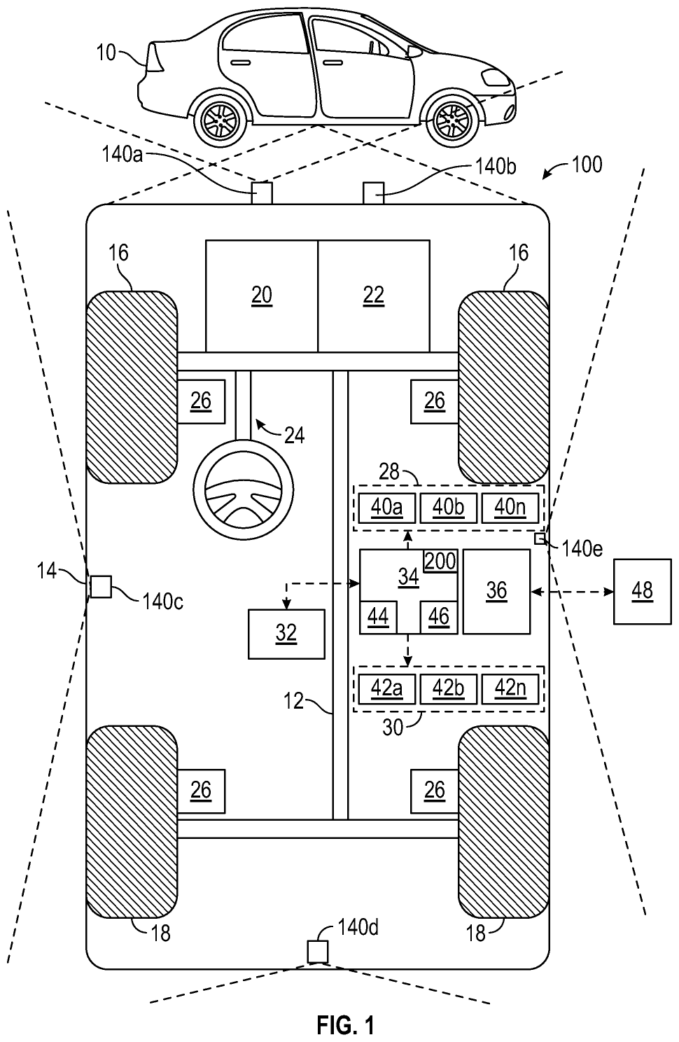

With reference to FIG. 1, a vehicle system shown generally at 100 is associated with a vehicle 10 in accordance with various embodiments. In general, the vehicle system 100 includes a lateral velocity estimation system 200 that is configured to receive time spaced representations of static objects and to estimate a lateral velocity of the vehicle 10 based on compensating for heading and longitudinal movement of the vehicle (as determined from sensor measurements) relative to the static objects in the time between the representations.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In some embodiments, the vehicle 10 is an autonomous vehicle and the lateral velocity estimation system 200 is incorporated into the autonomous vehicle 10 (hereinafter referred to as the autonomous vehicle 10). The present description concentrates on an exemplary application in autonomous vehicle applications. It should be understood, however, that the lateral velocity estimation system 200 described herein is envisaged to be used in semi-autonomous automotive vehicles.

The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver.

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the vehicle wheels 16-18. While depicted as including a steering wheel for illustrative purposes, in some embodiments contemplated within the scope of the present disclosure, the steering system 24 may not include a steering wheel.

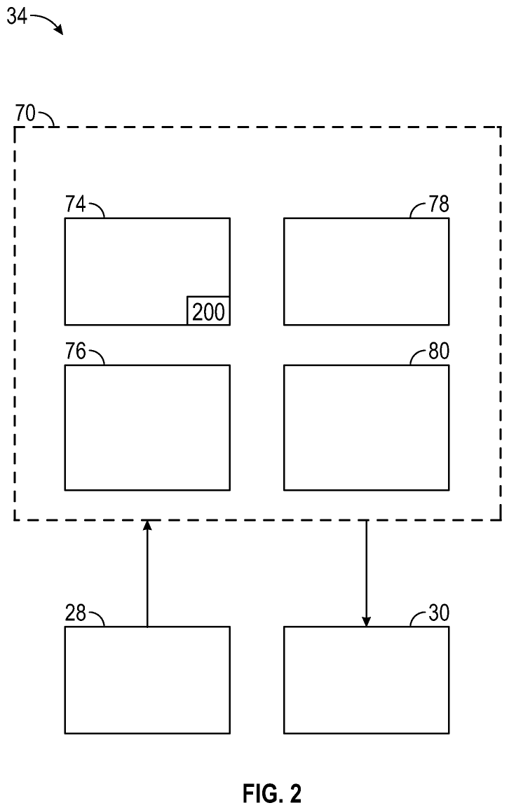

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras 140a-140n, thermal cameras, ultrasonic sensors, and/or other sensors. The optical cameras 140a-140n are mounted on the vehicle 10 and are arranged for capturing images (e.g. a sequence of images in the form of a video) of an environment surrounding the vehicle 10. In the illustrated embodiment, there are two front cameras 140a, 140b arranged for respectively imaging a wide angle, near field of view and a narrow angle, far field of view. Further illustrated are left-side and right-side cameras 140c, 140e and a rear camera 140d. The number and position of the various cameras 140a-140n is merely exemplary and other arrangements are contemplated. The sensing devices 40a-40n are part of a perception system 74 (see FIG. 2) that processes raw image data from the sensing devices 40a-40n to locate and classify features in the environment of the vehicle 10, particularly static objects used by the lateral velocity estimation system 200.

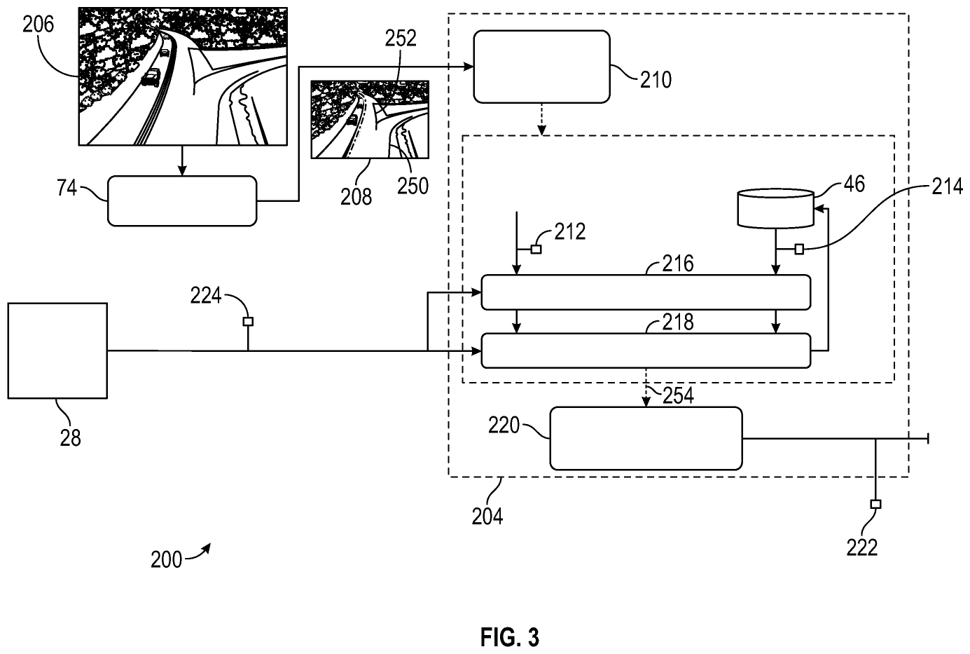

The sensor system 28 includes one or more of the following sensors that provide vehicle dynamics measurement data 224 (see FIG. 3) used by lateral velocity estimation system 200. The sensor system 28 may include a steering angle sensor (SAS), a wheel speed sensor (WSS), an inertial measurement unit (IMU), a global positioning system (GPS), an engine sensor, and a throttle and/or brake sensor. In embodiments, the sensor system 28 provides a measurement of translational/longitudinal speed and yaw rate for use by the lateral velocity estimation system 200.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

The data storage device 32 stores data for use in automatically controlling the autonomous vehicle 10. In various embodiments, the data storage device 32 stores defined maps of the navigable environment. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the lateral velocity estimation system 200 and, when executed by the processor 44, are configured to implement the methods and systems described herein for providing time-spaced representations of a static object, adjusting for motion of the vehicle 10 during the time delta based on a motion model and vehicle dynamics measurement data and comparing the relatively adjusted representations of the static object to determine a rate of change of the lateral position of the vehicle (i.e. lateral velocity). That is, a lateral spacing between the motion adjusted representation is indicative of lateral movement of the vehicle 10 over the time delta, which can be combined to output a lateral velocity estimation. The motion model uses yaw rate and longitudinal velocity to relatively adjust the representation for motion of the vehicle 10.

The communication system 36 is configured to wirelessly communicate information to and from other entities 48, such as but not limited to, other vehicles (“V2V” communication,) infrastructure (“V2I” communication), remote systems, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

As can be appreciated, the subject matter disclosed herein provides certain enhanced features and functionality to what may be considered as a standard or baseline autonomous vehicle 10. To this end, an autonomous vehicle can be modified, enhanced, or otherwise supplemented to provide the additional features described in more detail below. The subject matter described herein concerning the lateral velocity estimation system 200 is not just applicable to autonomous driving applications, but also other driving systems having one or more automated features utilizing a perception system, particularly hands free driving, lane keeping assistance, collision avoidance technology, particular those automated features that use an estimate of lateral motion.

In accordance with an exemplary autonomous driving application, the controller 34 implements an autonomous driving system (ADS) 70 as shown in FIG. 2. That is, suitable software and/or hardware components of the controller 34 (e.g., the processor 44 and the computer-readable storage device 46) are utilized to provide an autonomous driving system 70 that is used in conjunction with vehicle 10.

In various embodiments, the instructions of the autonomous driving system 70 may be organized by function, module, or system. For example, as shown in FIG. 2, the autonomous driving system 70 can include a perception system 74, a positioning system 76, a guidance system 78, and a vehicle control system 80. As can be appreciated, in various embodiments, the instructions may be organized into any number of systems (e.g., combined, further partitioned, etc.) as the disclosure is not limited to the present examples.

In various embodiments, the perception system 74 synthesizes and processes sensor data and predicts the presence, location, classification, and/or path of objects and features of the environment of the vehicle 10. In various embodiments, the perception system 74 can incorporate information from multiple sensors, including but not limited to cameras, lidars, radars, and/or any number of other types of sensors. The perception system 74 may detect static object such as environmental features (trees, hedgerows, buildings, etc.), static road features (such as curbs, lane markings, etc.) and traffic control features (such as traffic signs, traffic lights, etc.). These static objects can be tracked by the lateral velocity estimation system 200 to provide information on the lateral velocity of the vehicle 10 when each detection of a given static object is compensated for the motion of the vehicle 10 in terms of heading and longitudinal velocity over the time between the detections being compared.

The positioning system 76 processes sensor data along with other data to determine a position (e.g., a local position relative to a map, an exact position relative to lane of a road, vehicle heading, velocity, etc.) of the vehicle 10 relative to the environment. The guidance system 78 processes sensor data along with other data to determine a path for the vehicle 10 to follow. The vehicle control system 80 generates control signals for controlling the vehicle 10 according to the determined path. The guidance system 78 may utilize an estimated lateral velocity provided by the lateral velocity estimation system 200 to determine the path. The positioning system 76 may process a variety of types of localization data in determining a location of the vehicle 10 including Inertial Measurement Unit data, Global Positioning System (GPS) data, Real-Time Kinematic (RTK) correction data, cellular and other wireless data (e.g. 4G, 5G, V2X, etc.), etc.

In various embodiments, the controller 34 implements machine learning techniques to assist the functionality of the controller 34, such as feature detection/classification, obstruction mitigation, route traversal, mapping, sensor integration, ground-truth determination, and the like. One such machine learning technique performs traffic object detection whereby traffic objects are identified, localized and optionally the status is determined for further processing by the guidance system 78. The machine learning technique may be implemented by a DCNN. For example, a traffic object may be identified and localized. The feature detection and classification may be based on image data from the cameras 140a to 140n, LiDar data, Radar data, Ultrasound data or a fusion thereof. Some of the traffic objects as classified can be determined as being stationary or non-stationary depending on the classification. Various types of stationary objects or specific types of stationary objects can be used by the lateral velocity estimation system 200 in estimating lateral velocity of the vehicle 10.

As mentioned briefly above, the lateral velocity estimation system 200 of FIG. 1 (and FIGS. 2 and 3) is included within the ADS 70 in autonomous driving applications, for example in operable communication with the perception system 74, the positioning system 76, the guidance system 78 and the vehicle control system 80. The lateral velocity estimation system 200 is configured to estimate lateral velocity of the vehicle 10, which may be used by the guidance system 78 to plan a path of the vehicle and the vehicle control system 80 is responsive thereto to generate an automated control command. The vehicle control system 80 works with the actuator system 30 to traverse such a trajectory.

Referring to FIG. 3, with continued reference to FIGS. 1 and 2, the lateral velocity estimation system 200 is further illustrated in accordance with exemplary embodiments. The lateral velocity estimation system 200 includes functional modules that are performed by the programming instructions described hereinbefore. The lateral velocity estimation system 200 includes the perception system 74, the sensor system 28 and a lateral velocity estimation module 204. The perception system 74 provides static object detection data 208, which includes representations of one or more static objects for each frame (or fused frame) of raw perception data obtained from the sensing devices 40a to 40n. The representations can include bounding boxes, point clouds, lines or functions with associated classifications.

The perception system 74 may include a convolutional neural network (or other kind of artificial intelligence) that predicts locations for static objects and class probabilities for the static objects. The machine learning algorithm may be trained on labelled images. The locations may be provided in the form of bounding boxes, defined lines, point clouds or functions (e.g. a polynomial) representing size and location of the objects found in each frame of perception data. The classification can be analyzed as to static or moving, e.g. by cross-referencing with a predetermined list of targets that are workable with the further processing of the lateral velocity estimation system 200. In one exemplary embodiment, the perception system 74 proposes a convolutional neural network (CNN) for end-to-end lane markings estimation. The CNN takes as input images from a forward-looking camera mounted in the vehicle 10 and outputs polynomials that represent each lane marking in the image (via deep polynomial regression), along with the domains for these polynomials and confidence scores for each lane. The perception system 74 thus outputs static object detection data 208 to the lateral velocity estimation module 204 identifying, location and classifying static objects of interest (e.g. lane markings) along with an associated confidence of detection score.

In the exemplary embodiment, of FIG. 3, the lateral velocity estimation module 204 includes a confidence assignment sub-module 210, a comparison sub-module 216, a lateral velocity estimation sub-module 218 and a fusion sub-module 220. The confidence assignment sub-module 210 may assign additional confidence parameters to each detected static object based on heuristic considerations (e.g. prior knowledge of static object features that do not yield strong lateral velocity estimations). For example, a jump in a lane marking where there is a first part 250 of a lane marking following an off-ramp and a second part 252 that is a continuation of the main road marking after the off-ramp (which can be seen in FIG. 3). A view range of the detected static object (e.g. a distance away from the vehicle 10) may also direct a confidence value. For example, a greater distance away from the camera, a lower the confidence value. Driving conditions (e.g. visibility, longitudinal speed of vehicle and yaw rate) may also guide the confidence value assigned by the confidence assignment sub-module 210. The various confidence scores may be combined using a weighted average sum or some other combination function to arrive at a single confidence score for further processing or a confidence score vector may be provided that includes each type of confidence valuation.

The comparison sub-module 216 and the lateral velocity estimation sub-module 218 operate on each static object (possibly of one classification—e.g. lane markings) of a sufficient confidence score as provided by the perception system 74 and the confidence assignment sub-module 210. If the confidence score is too low, that static object is excluded either by discarding the static object from further processing or providing it with a zero weight in the fusion sub-module 220, which is described later. Generally, the comparison sub-module 216 receives current static object detection data 212 (including a first representation of current detections of each static object) and earlier static object detection data 214 (including a second representation of earlier detections of each static object). The earlier static object detection data 214 may be obtained from computer readable storage device or media 46 (such as RAM). The current static object detection data 212 and the earlier static object detection data 214 may be associated with a timestamp so that a time difference between current and earlier detections is known. The current and earlier static object detection data 214 may flow from successive frames output by the perception system 74. Taking a single static object detection as an example, the comparison sub-module 216 transforms an overlapping window of the static object that is available from the current and earlier static object detection and relatively transforms them into a common coordinate frame and takes into account longitudinal and angular motion of the vehicle 10 based on a motion model and the longitudinal velocity and yaw rate obtained from the vehicle dynamics measurement data 224. The relatively transformed current and earlier static detections can be laterally spatially matched to one another to determine a lateral spatial difference. The lateral spatial difference can be combined with the time difference by the lateral velocity estimation sub-module 218 to determine an estimate of lateral velocity. This process may be repeated for each detected static object (of sufficient confidence score) in the current and earlier static object detection data 212, 214 to obtain a plurality of lateral velocity estimates 254 for the vehicle 10. The fusion sub-module 220 combines the plurality of lateral velocity estimates into a single value, e.g. by an averaging function of some kind such as a weighted function (which will be described in greater detail below). The fusion sub-module 220 outputs an estimated lateral velocity 222. The estimated lateral velocity 222 can be used in various vehicle control functions such as path planning, estimating time to lane crossing, time to collision, which ultimately result in steering, propulsion and/or braking commands for the actuator system 30.

In embodiments, the comparison sub-module 216 is operable on different kinds of representations of static objects including point clouds, bounding boxes, lines and polynomial representations of line features. The comparison sub-module 216 may, in one embodiment, find a set of points spatially coinciding with the same static object in the current detection and the earlier detection within an overlapping window (described further below) and the current and earlier points may be relatively transformed into the same coordinate frame and compensated for longitudinal and angular motion of the vehicle 10. The lateral velocity may be estimated, by the lateral velocity estimation sub-module 218, based on relative lateral motion of the transformed points and the time difference between the current and earlier detections. In one embodiment, the plurality of lateral velocity estimates 254 are fused, by the fusion sub-module 220, according to object detection confidence scores to provide the estimated lateral velocity 222 (which is model independent).

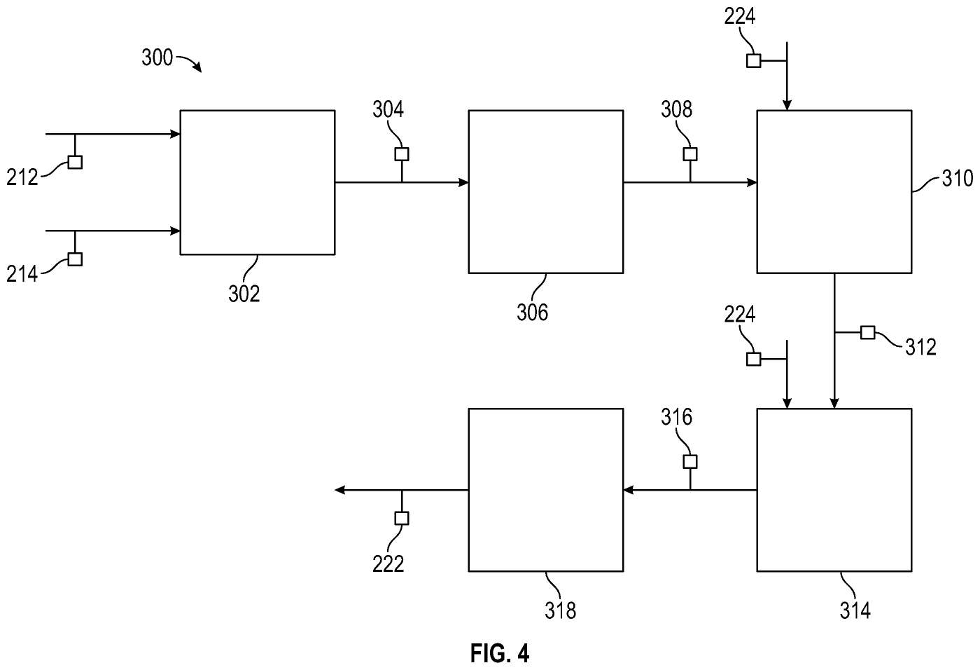

Referring to FIG. 4, an example of the static object comparison and lateral velocity estimation process 300. In the example of FIG. 4, the current static object detection data 212 and the earlier static objection detection data 214 includes representations of linear feature detections in the form of a function (e.g. a polynomial) as provided by the perception system 74. The linear feature detections may be road markings. The linear features detections could, alternatively, be provided in the form of point clouds or bounding boxes or lines and the lateral velocity estimation sub-module 204 may fit the linear features detections to a function.

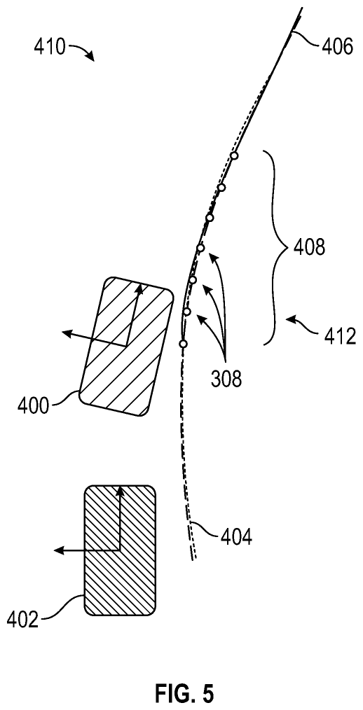

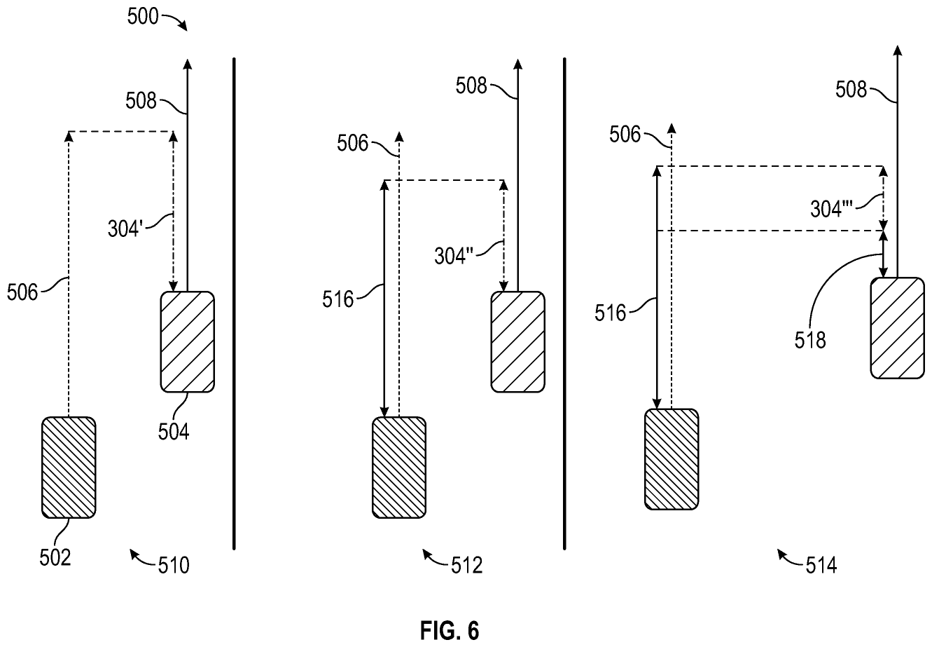

At 302, an overlap window W is determined. The overlap window corresponds to coinciding regions of the static object detections that appear in both current detection of a static object and a previous detection of the static object and which spatially overlap with one another (prior to any vehicle motion compensation). Referring to FIG. 5, the overlapping window 412 is illustrated. FIG. 5 is an exemplary diagram of static object detections 410 in which the vehicle at time k−1 402 provides a previous detection of a static object 404 and a vehicle at time k (current time) provides a latest (or current) detection of the static object 406. An end of range region of the previous detection of the static object 404 overlaps with a start of range region of the latest detection of the static object 406. This provides an overlapping window 412 between the previous and latest detections of the static object 404, 406. In some embodiments, only part of the overlapping window 412 is taken as a valid window. Referring to FIG. 6, a process 500 for determining a valid window is illustrated according to first, second and third exemplary processes 510, 512, 514. The process 500 for determining the valid window is performed by the step 303 in FIG. 4. In a first exemplary process, the valid window 304′ is taken as the full overlap region between the previous view range 506 of the perception system 74 of the vehicle 502 at a previous time step and the current view range 508 of the perception system 74 of the vehicle 504 at the current time step. In a second exemplary process 512, a calibratable maximum distance 516 is assumed in association with the previous view range 506, which makes up part of the previous view range 506. The valid window 304″ is taken as the overlap region between the calibratable maximum distance 516 and the current view range 508. In a third exemplary process 514, the current view range 508 is associated with a calibratable minimum distance 518 that is part of the current view range 508 set the calibratable minimum distance away from the vehicle 518 at the current time step. The valid window 304′″ is taken as the overlap region between the calibratable maximum distance 516 of the previous view range 506 and the calibratable minimum distance 518 of the current view range 508. The calibratable maximum and minimum distances 516, 518 are set in view of detections that are close to the vehicle 10 and detections that are at the end of the view range may not be as high in accuracy.

Referring back to FIGS. 4 and 5, the valid window 304 is received at process step 306 of constructing points for the latest (or current) detection of the static object along the valid window 304. Referring to FIG. 5, the points 308 so defined are included in the overlapping window 408, which is taken in full as the valid window 304 in this example. The points 308 are constructed based on the function representing the latest detection of the static object 406. The number and spacing of the points are a calibratable value but there should be a sufficiently granular number of points to fully represent the latest detection of the static object 406 in the valid window 304. In order to construct the points, the function representing the latest detection of the static object 406 is resolved at evenly spaced y values to obtain the x coordinate, where the function is a polynomial relating x and y coordinates in the coordinate frame of the vehicle at time k.

At step 310, the points 308 are transformed into an earlier coordinate frame, which is the coordinate frame of the vehicle at time k−1. The following equations can be used to perform the process of step 310:

\dot{x}_{gbl}=cos(Ψ)Vₓ−sin(Ψ)V_{y} (equation 1)

\dot{y}_{gbl}=cos(Ψ)V_{y}+sin(Ψ)Vₓ (equation 2)

\dot{Ψ}=ω_{z} (equation 3)

Equations 1 and 2 are equations of motion (a motion model) of the vehicle 10 in 2D space. These equations can be integrated over time elapsed (Δt) between the previous and current detections of the static object to give (Δx), (Δy) and (ΔΨ), which represent change in longitudinal position, change in lateral position and change in heading, respectively. ω_{z} represents yaw rate. Assuming that W represents the points 308, ƒ_{new} represents a function defining the latest detection of the static object 406 (see FIG. 5) and ƒₚᵣₑᵥ represents a function defining the previous detection of the static object 404, then:

W′=W cos(ΔΨ)−ƒ_{new}(W)sin(ΔΨ)+Δx (equation 4)

Equation 3 translates the window of points W into the earlier coordinate frame.

Perception (e.g. camera) data 206 may be available at a slower sample rate than other data (e.g. speed and yaw rate) from the sensor system 28. Speed and yaw rate can be consumed by this lateral velocity estimation system 200 at the higher sample rate, and the motion model included in equations 1 and 2 can be integrated at that faster rate. Then, the lateral velocity estimated is the “average” over the longer time period between the two camera samples consisting of the current static object detection data 212 and the earlier static object detection data 214. In this way, longitudinal motion and rotation are more accurately compensated.

Continuing to refer to FIG. 4, step 314 includes evaluating the earlier detection of the static object at the transformed points 312 provided by step 310. As such, ƒₚᵣₑᵥ is evaluated at W′, and the result is translated back to the coordinate frame of the vehicle at time k (current time). Step 314 thus provides expected points 316 (which is denoted Y* in the following):

Y*=(ƒₚᵣₑᵥ(W′)−Δy)cos(ΔΨ)+(W′−Δx)sin(ΔΨ) (equation 5)

In equations 3 and 4 the change in heading and the change in longitudinal position Δx can be derived from yaw rate and longitudinal speed in the vehicle dynamics measurement data 224. The change in lateral position Δy is an unknown that can be solved, thereby making it possible to estimate lateral velocity V_{y}.

In step 318 the expected points 316 and the points 308 are compared to estimate lateral velocity Δy. That is, steps 310 and 314 relatively transform the points 308 to compensate for heading and longitudinal motion change of the vehicle 10 and bring the longitudinally corresponding points (according to the function ƒₚᵣₑᵥ) from the earlier detection into the same coordinate frame as the points 308 from the current detection. These two sets of points are compared to one another in terms of lateral offset to obtain an estimate of lateral velocity when the time delta Δt is factored in. In one embodiment, the comparison of step 318 minimizes the following argument to estimate lateral velocity:

$${V}_{y} = \frac{arg min}{{V}_{y}} \sum {( {f}_{n e w} ( W ) - {Y}^{*} )}^{2} \qquad ( equation 6 )$$

Equation 5 minimizes an error between the points 308 and the expected points 316. That is, equation 5 produces the value of lateral velocity that minimizes the sum of the difference between the points 308 and the expected points 316. This value of lateral velocity corresponds to the estimated lateral velocity 222 for one of the detected static objects.

In one embodiment, each of the points 308 is assigned a weighting (wⱼ) that increases in dependence on a closeness of the point to the vehicle 10. This accounts for location accuracy of the point likely being greater nearer the vehicle than further away. In such an embodiment, the argument of equation 5 includes weights (wⱼ) associated with each point j as follows:

$${V}_{y} = \frac{arg min}{{V}_{y}} {\sum }_{j} {{w}_{j} ( {f}_{n e w} ( {W}_{j} ) - {Y}^{*} )}^{2} \qquad ( equation 7 )$$

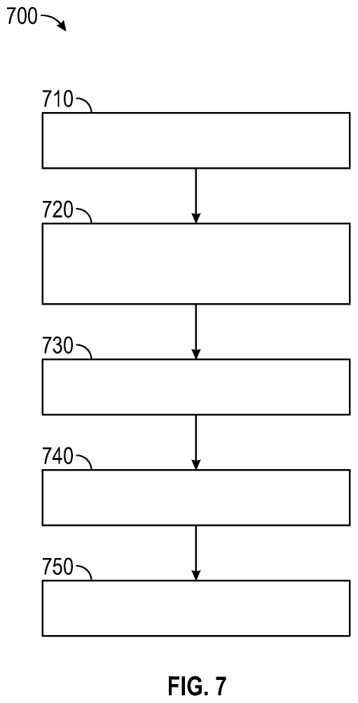

Referring now to FIG. 7, and with continued reference to FIGS. 1-6, a flowchart illustrates a method 700 of lateral velocity estimation that can be performed by the lateral velocity estimation system 200 of FIG. 3 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure. In various embodiments, the method 700 can be scheduled to run based on one or more predetermined events, and/or can run continuously during operation of the autonomous vehicle or semi-autonomous vehicle 10.

At 710, the static object detection data 208 is received from the perception system 74. The static object detection data 208 includes successive frames including representation of static object detections. The frames are separated by a time delta. The representations may each be a polynomial function defining a lane marking.

At step 720, the expected position of the static object from the earlier representation of the static object is estimated. The estimation of the expected position is based on compensating the position of the earlier representation for relative movement of the vehicle 10 in a longitudinal direction and in terms of heading based on the time delta, the vehicle dynamics measurement data 224 (specifically longitudinal speed and yaw rate) and a motion model. Only part of the earlier representation that overlaps with the current representation of the static object in the viewing range of the perception system 74 need be compensated. The overlapping part may be discretized into points to facilitate the calculations. Further, the compensated version of the earlier representation and the current representation of the static object, which may be devolved as points using the functions defining the representations, are placed in the same coordinate frame. In step 730, the expected (which is transformed from the earlier position of the static object) and current positions of the static objects are compared (when in the common coordinate frame), specifically to determine a lateral offset therebetween, which can be transformed to a lateral velocity when combined with the time delta in step 740. In one embodiment, steps 730 and 740 are performed by finding the lateral velocity that is produced when a disparity between the expected and current positions of the static object is minimized. When there is a plurality of static object detections, these are included or excluded based on conditions such as sufficient perception confidence, lane conditions not being in an excluded list (e.g. lane marking jump), the detections are within a maximum view range, driving conditions are not outside of acceptable limits (e.g. in terms of yaw rate, longitudinal speed, visibility, etc.). Even when included, each static object detection may be associated with a weight. The weight may be based on perception confidence score, distance to the feature from the vehicle and other relevant factors. Those static object detections that are to be excluded may be given a weight of zero. The plurality of lateral velocity estimates 254 are combined in a weighted sum average function to arrive at the estimated lateral velocity 222 for the vehicle 10.

In step 750, the estimated lateral velocity 222 is used in controlling the vehicle 10, particularly an automated feature of the vehicle 10. The estimated lateral velocity 222 may be used in path finding and the vehicle 10 may be controlled in terms of steering, propulsion and/or braking to follow the path. The automated control feature may be collision avoidance, lane keeping, other automated driver assistance technology or hands free driving, for example.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a vehicle, the method comprising:
receiving, via at least one processor, static object detection data from a perception system of the vehicle, the static object detection data including a first representation of a static object at a current time and a second representation of the static object at an earlier time;
receiving, via the at least one processor, vehicle dynamics measurement data from a sensor system of the vehicle;
determining, via the at least one processor, a current position of the static object based on the first representation of the static object;
predicting, via the at least one processor, an expected position of the static object at the current time using the second representation of the static object at the earlier time, a motion model and the vehicle dynamics measurement data;
estimating, via the at least one processor, a lateral velocity of the vehicle based on a disparity between the current position and the expected position; and
controlling, via the at least one processor, the vehicle using the lateral velocity.

2. The method of claim 1, comprising determining, via the at least one processor, an earlier position of the static object using the second representation of the static object at the earlier time, wherein predicting the expected position of static object at the current time uses the second representation of the static object at the earlier time, the motion model, the vehicle dynamics measurement data and the earlier position of the static object.

3. The method of claim 2, wherein the disparity is determined by the at least one processor using a window having an overlapping representation of the static object that appears in the first representation and the second representation.

4. The method of claim 1, wherein the first representation of the static object and the second representation of the static object are in the form of first and second functions, respectively.

5. The method of claim 1, comprising determining, via the at least one processor, a first set of points coinciding with the first representation of the static object, transforming, via the at least one processor, the first set of points into a coordinate frame of the second representation of the static object using the motion model and the vehicle dynamics measurement data to provide a transformed set of points, wherein predicting, via the at least one processor, the expected position of the static object at the current time uses the second representation of the static object at the earlier time, the motion model, the vehicle dynamic measurement data and the transformed set of points.

6. The method of claim 1, wherein the first representation of the static object and the second representation of the static object are in the form of first and second functions, respectively, and wherein the method comprises determining, via the at least one processor, a first set of points using the first function, transforming, via the at least one processor, the first set of points into a coordinate frame of the second representation of the static object using the motion model and the vehicle dynamics measurement data to provide a transformed set of points, wherein predicting, via the at least one processor, an expected position of the static object at the current time comprises evaluating the second function with respect to the transformed set of points to provide a second set of points and translating the second set of points into a coordinate from of the first representation to provide an expected set of points, and wherein estimating the lateral velocity of the vehicle is based on a disparity between the first set of points and the expected set of points.

7. The method of claim 1, wherein estimating the lateral velocity of the vehicle is based on a function that minimizes an error between the current position and the expected position, wherein the function corresponds to the disparity.

8. The method of claim 1, wherein the static object is a lane marking.

9. The method of claim 1, comprising performing, for each of a plurality of static objects in the static object detection data: the determining the current position of the static object, predicting the expected position of the static object and the estimating the lateral velocity of the vehicle, to thereby provide a plurality of estimates of the lateral velocity of the vehicle, wherein the method comprises combining the plurality of estimates of the lateral velocity to provide a combined estimate, wherein controlling the vehicle is based on the combined estimate.

10. The method of claim 9, wherein combining the plurality of estimates includes evaluating a weighted sum function.

11. The method of claim 10, wherein weights of the weighted sum function are set depending on a distance away from the vehicle that each of the plurality of static objects is located.

12. The method of claim 10, wherein weights of the weighted sum are set depending on a perception confidence associated with each static object provided by the perception system.

13. The method of claim 10, comprising excluding a static object from the estimating the lateral velocity of the vehicle when perception confidence provided by the perception system is insufficient and/or when the static object is located too far away from the vehicle according to predetermined exclusion thresholds.

14. A system for controlling a vehicle, the system comprising:
a perception system;
a sensor system;
at least one processor in operable communication with the sensor system and the perception system, wherein the at least one processor is configured to execute program instructions, wherein the program instructions are configured to cause the at least one processor to:
receive static object detection data from the perception system, the static object detection data including a first representation of a static object at a current time and a second representation of the static object at an earlier time;
receive vehicle dynamics measurement data from the sensor system;
determine a current position of the static object based on the first representation of the static object;
predict an expected position of the static object at the current time using the second representation of the static object at the earlier time, a motion model and the vehicle dynamics measurement data;
estimate a lateral velocity of the vehicle based on a disparity between the current position and the expected position; and
control the vehicle using the lateral velocity.

15. The system of claim 14, wherein the program instructions are configured to cause the at least one processor to: determine an earlier position of the static object using the second representation of the static object at the earlier time, wherein predicting the expected position of the static object at the current time uses the second representation of the static object at the earlier time, the motion model, the vehicle dynamics measurement data and the earlier position of the static object.

16. The system of claim 15, wherein the disparity is determined by the at least one processor using a window having an overlapping representation of the static object that appears in the first representation and the second representation.

17. The system of claim 14, wherein the first representation of the static object and the second representation of the static object are in the form of first and second functions, respectively.

18. The system of claim 14, wherein the program instructions are configured to cause the at least one processor to: determine a first set of points coinciding with the first representation of the static object, transform the first set of points into a coordinate frame of the second representation of the static object using the motion model and the vehicle dynamics measurement data to provide a transformed set of points, wherein predicting an expected position of the static object at the current time uses the second representation of the static object at the earlier time, the motion model, the vehicle dynamic measurement data and the transformed set of points.

19. The system of claim 14, wherein the first representation of the static object and the second representation of the static object are in the form of first and second functions, respectively, and wherein the program instructions are configured to cause the at least one processor to: determine a first set of points using the first function, transform the first set of points into a coordinate frame of the second representation of the static object using the motion model and the vehicle dynamics measurement data to provide a transformed set of points, wherein predicting the expected position of the static object at the current time comprises evaluating the second function with respect to the transformed set of points to provide a second set of points and translating the second set of points into a coordinate from of the first representation to provide an expected set of points, and wherein estimating the lateral velocity of the vehicle is based on a disparity between the first set of points and the expected set of points.

20. The method of claim 14, wherein estimating the lateral velocity of the vehicle is based on a function that minimizes an error between the current position and the expected position, wherein the function corresponds to the disparity.
